(19) United States
(12) Patent Application Publication
(10) Pub. No.: US 2005/0283483 A1
(43) Pub. Date: Dec. 22, 2005

(54) Information contents download system

(75) Inventors: Minoru Okamoto, Osaka (JP); Katsuhiko Ueda, Osaka (JP); Shirou Yoshioka, Hyogo (JP); Tetsuji Kishi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/152,091

(22) Filed: Jun. 15, 2005

(30) Foreign Application Priority Data
Jun. 21, 2004 (JP) P2004-182539

(51) Int. Cl. G06F 17/30

(52) U.S. Cl. 707/10

(57) ABSTRACT

A terminal device transmits device information thereof and a request for acquiring information contents to a contents distribution device. The contents distribution device generates a request for distributing a program for materializing the information contents in the terminal device based on the information contents designated in the acquisition request and the device information, and transmits the distribution request to a program distribution device and transmits the device information to an inspection device. The program distribution device transmits the program in the distribution request to the inspection device. The inspection device inspects a materialization state of the information contents in the terminal device based on the program and the device information and transmits a result of the inspection to the program distribution device and the contents distribution device. The program distribution device transmits the program to the terminal device and the contents distribution device transmits the information contents to the terminal device only when the inspection result is favorable.

### BACKGROUND OF THE INVENTION

1. Field of the Invention

The present invention relates to a configuration for downloading information contents and a program used for materializing the information contents and a processing system for any charge generated in the download.

2. Description of the Related Art

An advancement of a broadband communication technology in recent years has been facilitating the transmission/reception of information contents of various types (image, music and the like), whose too a large information volume had always been a bottleneck in a communication process. Further, it is now being realized to materialize all of required functions on software using a terminal device in response to an increasingly higher performance achieved in LSI. For example, when image data of MPEG4, which cannot be reproduced when the terminal device is in an initial state, can be reproduced by acquiring a reproduction function (reproduction program) of the MPEG4 in a download process or the like via the internet and installing the function in the terminal device. A part of such an extensible and flexible function-adding configuration is increasingly materialized in the reconfigurable DSP (Digital Signal Processor) and the like. As an example of a conventional technology relating to the present invention can be mentioned an invention relating to a method of distributing software to a terminal recited in US6026366A of the Publication of the US Patents.

As the extensibility and flexibility in acquiring the functions are more enhanced, there is a strong demand for building a communication management system for handling transactions of acquiring the information contents and functions. Further, it is required in the communication management to acquire the information contents and functions while minimizing a possibility of generating a failure in the functions of respective terminal devices.

### SUMMARY OF THE INVENTION

Therefore, a main object of the present invention is to build a communication management system for handling transactions of acquiring information contents and functions.

In order to solve any existing problem, the present invention comprises the following components. First, a constitution according to the present invention in a system basically adapted to transmit and receive the information contents is described.

The system according to the present invention comprises a terminal device comprising a hardware configuration capable of materializing optional information contents by adding a predetermined function thereto, a contents distribution device for distributing the information contents, a program distribution device for distributing a program for realizing the function used for the materialization in the terminal device of the information contents in the terminal device, and an inspection device for reproducing and inspecting an execution state of the program in the terminal device, wherein these devices are connected to one another to enable an intercommunication via an electric communication line.

The terminal device transmits device information of the terminal device and a request for acquiring information contents desired by a user of the terminal device identified based on an instruction input operation implemented to the terminal device by the user to the contents distribution device. The information contents desired by the user are received from the contents distribution device and the program required for the materialization of the desired information contents is received from the program distribution device. The information contents are materialized by means of the function acquired in the execution the received program.

The contents distribution device judges whether or not a new program for realizing the function for materializing the information contents in the terminal device transmitting the acquisition request is necessary based on the information contents required in the acquisition request received from the terminal device and the device information attached to the acquisition request. The contents distribution device transmits the information contents required in the received acquisition request to the terminal device when the new program is judged to be unnecessary. The contents distribution device designates the new program when it is judged to be necessary, and transmits a request for distributing the designated program to the program distribution device and transmits the device information of the terminal device transmitting the acquisition request to the inspection device.

The program distribution device transmits the program designated in the distribution request received from the contents distribution device to the inspection device.

The inspection device reproduces a materialization state of the information contents using the program in the terminal device based on the program received from the program distribution device and the device information received from the contents distribution device and inspects a reproduction state thereof, and transmits a result of the inspection to the program distribution device and the contents distribution device.

The program distribution device transmits the program designated in the distribution request to the terminal device only when the inspection result received from the inspection device is favorable.

In the case of demanding the new program in the terminal device, the contents distribution device transmits the information contents designated in the received acquisition request to the terminal device only when the inspection result received from the inspection device is favorable.

Next, a constitution according to the present invention in a system basically adapted to transmit and receive the function is described.

The system according to the present invention comprises a terminal device comprising a hardware configuration capable of realizing an optional function on software, a program distribution device for distributing a program for realizing the function in the terminal device, a distribution management device for managing the distribution of the program, and an inspection device for reproducing and inspecting an execution state of the program in the terminal device, wherein these devices are connected to one another to enable an intercommunication via an electric communication line.

The terminal device transmits device information of the terminal device and a request for acquiring a function desired by a user of the terminal device identified based on an instruction input operation implemented to the terminal device by the user to the distribution management device. The program corresponding to the function desired by the user is received from the program distribution device and the received program is executed.

The distribution management device designates the program necessary for realizing the function in the terminal device transmitting the acquisition request based on the function designated in the acquisition request received from the terminal device and the device information attached to the acquisition request, and then, transmits a request for distributing the designated program to the program distribution device and further transmits the device information of the terminal device transmitting the acquisition request to the inspection device.

The program distribution device transmits the program designated in the distribution request received from the distribution management device to the inspection device.

The inspection device reproduces an execution state of the program in the terminal device based on the program received from the program distribution device and the device information received from the distribution management device and inspects a reproduction state thereof, and transmits a result of the inspection to the program distribution device only when the inspection result received from the inspection device is favorable.

The program distribution device transmits the program, which is necessary for realizing the function desired by the terminal device in the terminal device, to the terminal device.

According to the present invention, the user of the terminal device can acquire the desired function and the function necessary for the desired information contents after the completion of the inspection whether or not the function can accurately operate in his/her terminal device by merely transmitting the requests for the desired information contents and function to the contents distribution device and the distribution management device. Therefore, a level of convenience for the user of the terminal device can be remarkably increased.

Further, a charge for acquiring the function used for materializing the information contents (to be specific, program for realizing the function in the terminal device) and a charge for inspecting the program are added to a charge for acquiring the information contents, which can be collectively charged. Thereby, it becomes unnecessary for the user of the terminal device to pay the function (program) acquiring charge and the inspection charge separately. Thus, the level of convenience for the user of the terminal device can be remarkably increased in terms of the payment as well.

In the same manner, the charge for inspecting the program is added to the charge for acquiring the function (program), which can be collectively charged. Thereby, it becomes unnecessary for the user of the terminal device to pay the inspection charge separately. The level of convenience for the user of the terminal device can be also remarkably increased in this regard.

In the case of providing a plurality of program distribution devices and inspection devices, introduction information of those devices may be transmitted to the terminal device allowing the user of the terminal device to select optional devices from the introduced devices. Accordingly, the user of the terminal device can have a choice for the program distribution device and the inspection device, which further increases the level of convenience.

### BRIEF DESCRIPTION OF THE DRAWINGS

These and other objects as well as advantages of the invention will become clear by the following description of preferred embodiments and explicit in the appended claims of the invention. Many other benefits of the invention not cited in this specification will come to the attention of those skilled in the art upon implementing the present invention.

FIG. 1 shows a constitution of a download system according to a preferred embodiment of the present invention operating as a function download system or an information contents download system.

FIG. 2 is a block diagram of a terminal device constituting the download system according to the embodiment.

FIG. 3 is a block diagram of a contents distribution device constituting the download system according to the embodiment.

FIG. 4 is a block diagram of a program distribution device constituting the download system according to the embodiment.

FIG. 5 is a block diagram of an inspection device constituting the download system according to the embodiment.

FIG. 6 is a block diagram of a settlement management device constituting the download system according to the embodiment.

FIG. 7 is a flow chart of an operation of the terminal device in the case of operating the download system as the information contents download system.

FIG. 8 is a flow chart of an operation of the contents distribution device in the case of operating the download system as the information contents download system.

FIG. 9 is a flow chart of an operation of the program distribution device in the case of operating the download system as the information contents download system.

FIG. 10 is a flow chart of an operation of the inspection device in the case of operating the download system as the information contents download system.

FIG. 11 is a flow chart of an operation of the terminal device in the case of operating the download system as the function download system.

FIG. 12 is a flow chart of an operation of the contents distribution device in the case of operating the download system as the function download system.

FIG. 13 is a flow chart of an operation of the program distribution device in the case of operating the download system as the function download system.

FIG. 14 is a flow chart of an operation of the inspection device in the case of operating the download system as the function download system.

FIG. 15 is a flow chart of a precedent-stage operation of a terminal device according to a first modified example of the embodiment.

FIG. 16 is a flow chart of a precedent-stage operation of a contents distribution device according to the first modified example of the embodiment.

FIG. 17 is a flow chart of a precedent-stage operation of a terminal device according to a second modified example of the embodiment.

FIG. 18 is a flow chart of a precedent-stage operation of a contents distribution device according to the second modified example of the embodiment.

FIG. 19 is a flow chart of an operation of the settlement management device in the case of operating the download system as the information contents download system.

FIG. 20 is a flow chart of an operation of the settlement management device in the case of operating the download system as the function download system.

### DETAILED DESCRIPTION OF THE INVENTION

Hereinafter, a preferred embodiment of the present invention is described referring to the drawings.

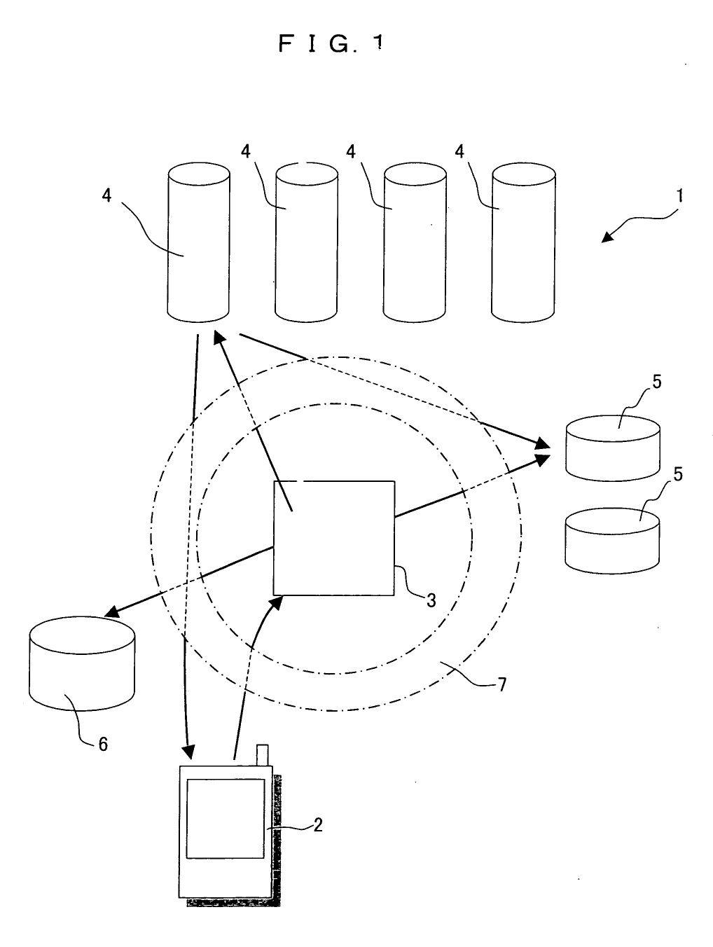

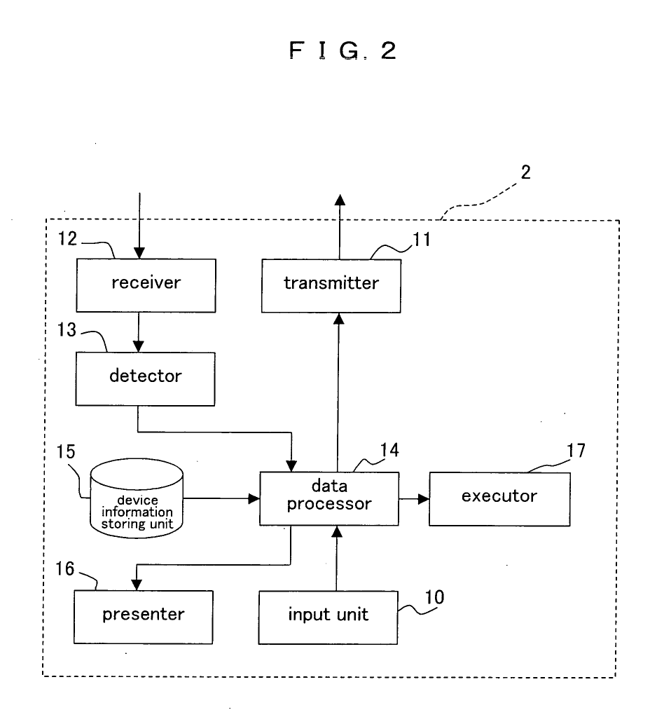

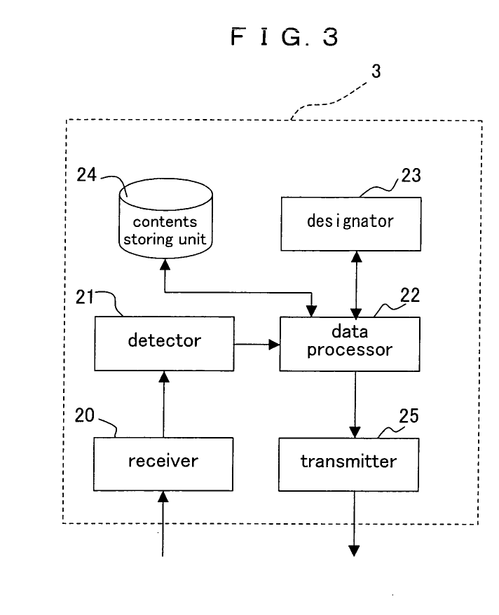

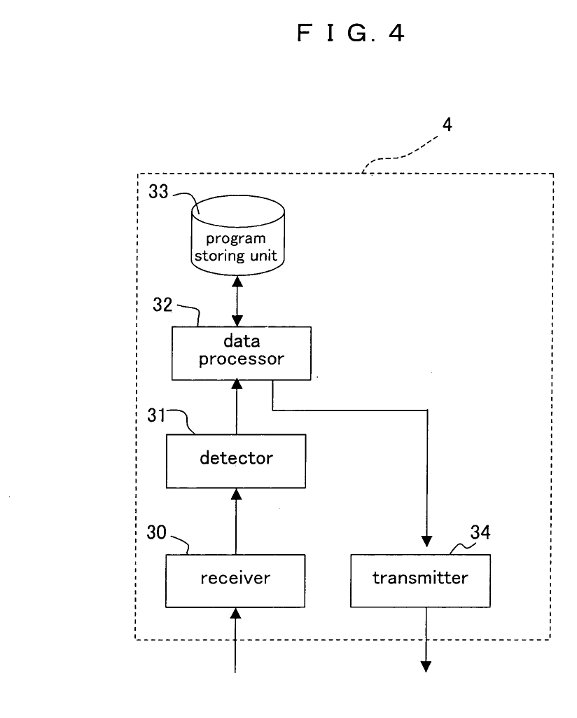

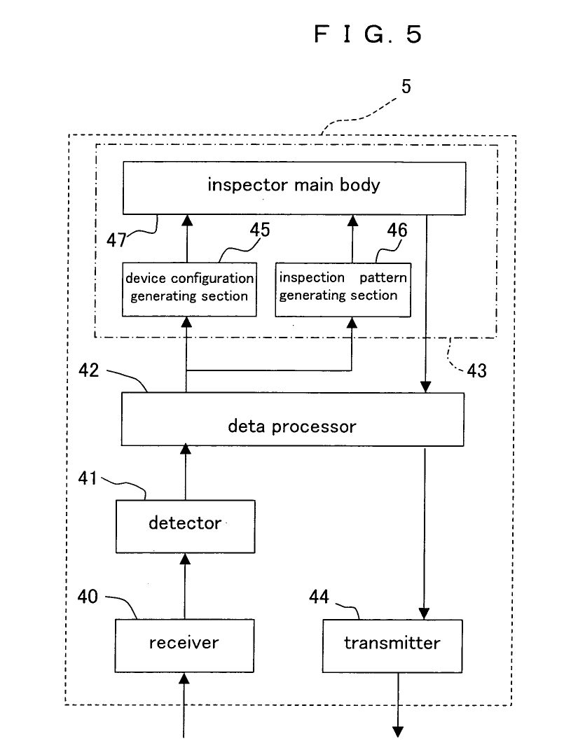

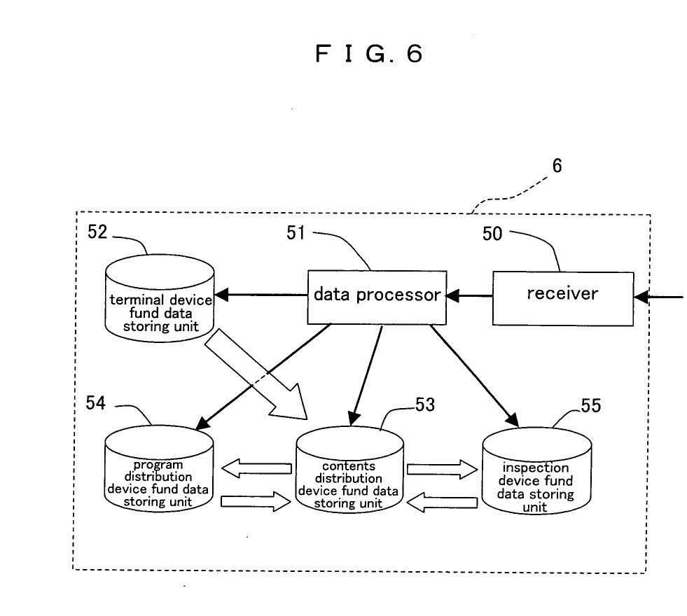

FIG. 1 shows a constitution of a download system 1 according to a preferred embodiment of the present invention. FIG. 2 is a block diagram of a terminal device 2 constituting a part of the system 1. FIG. 3 is a block diagram of a contents distribution device 3 constituting apart of the system 1. FIG. 4 is a block diagram of a program distribution device 4 constituting a part of the system 1. FIG. 5 is a block diagram of an inspection device 5 constituting a part of the system 1. FIG. 6 is a block diagram of a settlement management device 6 constituting a part of the system 1.

The download system 1 comprises the terminal device 2, contents distribution device 3, program distribution device 4, inspection device 5 and settlement management device 6, wherein these devices 2 through 6 are connected to one another to enable an intercommunication via an internet line 7 which is an example of an electric communication line.

The terminal device 2 comprises a hardware configuration capable of materializing optional information contents by adding a predetermined function thereto. The present embodiment is premised on that a plurality of uses each has the terminal device 2. The present embodiment is further premised on that a plurality of terminal devices 2 respectively having a different device configuration is variously provided.

The contents distribution device 3 distributes the information contents via the internet line 7. The program distribution device 5 distributes a program for realizing in the terminal device 2 a function used in materializing the information contents in the terminal device 2 through the internet line 7. The inspection device 4 reproduces and inspects an execution state of the program in the terminal device 2 without using the terminal device 2.

The terminal device 2 comprises, as shown in FIG. 2, an input unit 10, a transmitter 11, a receiver 12, a detector 13, a data processor 14, a device information storing unit 15, a presenter 16 and an executor 17.

The input unit 10 has a function of receiving an instruction input operation carried out to the terminal device 2 by the user of the terminal device 2. The transmitter 11 has a function of transmitting signals of various types to the contents distribution device 3 via the internet line 7. The receiver 12 has a function of receiving signals of various types via the internet line 7. The detector 13 has a function of detecting whether or not the signal of various types are received in the receiver 12. The data processor 14 has a function of generating a signal to be transmitted via the internet line 7, a function of retrieving data from a signal received via the internet line 7 and a function of executing various signal processes to the data. The device information storing unit 15 is a database for storing device information of the terminal 10 device 2. The device information is information representing the hardware configuration of the terminal device 2 and a configuration of a program (software) already installed in the terminal device 2. The program refers to software for realizing in the terminal device 2 the function used in materializing the various contents information in the terminal device 2. The presenter 16 comprises a display device, an audio generator and the like and has a function of presenting (display, audio processing and the like) the various information contents retrieved from the received (downloaded) signal to the user of the terminal device 2. The executor 17 has a function of materializing the various information contents by realizing an optional function in the terminal device 2. The respective functions are realized in the terminal device 2 through the execution of the previously stored program or program retrieved from the received signal. The term, program, used in this description refers to the foregoing programs. Further, a constitution of the executor 17 (a processing performance and a type of processable data in the executor 17) and a type and number of the programs already installed in the executor 17 are different in the respective terminal devices 2, which constitutes a part of function information.

The contents distribution device 3 comprises, as shown in FIG. 3, a receiver 20, a detector 21, a data processor 22, a designator 23, a contents storing unit 24 and a transmitter 25. The receiver 20 has a function of receiving the signal of various types via the internet line 7.

The detector 21 has a function of detecting whether or not the signals of various types are received in the receiver 20. The data processor 22 has a function of generating a signal to be transmitted via the internet line 7, a function of retrieving various data from a signal received via the internet line 7 and a function of executing various signal processes to the data. The designator 23 has a function of designating optional information contents, a function required for materializing the information contents and program for realizing the function in the respective terminal devices 2 based on the data retrieved by the data processor 22. The contents storing unit 24 is a database for storing the various information contents such as image data and music data and has a function of identifying and reading optional contents from the stored information contents based on the designation of the designator 23. The transmitter 25 has a function of transmitting the signal generated in the data processor 22.

The program distribution device 4 comprises, as shown in FIG. 4, a receiver 30, a detector 31, a data processor 32, a program storing unit 33 and a transmitter 34. The receiver 30 has a function of receiving signals of various types via the internet line 7. The detector 31 has a function of detecting whether or not the signals of various types are received in the receiver 30. The data processor 32 has a function of generating a signal to be transmitted via the internet line 7, a function of retrieving various data from a signal received via the internet line 7 and a function of executing various signal processes to the data. The program storing unit 33 is a database for storing a program required for realizing an optional function in the terminal device 2. The transmitter 34 has a function of transmitting the signal generated in the data processor 32.

The inspection device 5 comprises, as shown in FIG. 5, a receiver 40, a detector 41, a data processor 42, an inspector 43 and a transmitter 44. The inspector 43 comprises a device configuration generating section 45, an inspection pattern generating section 46 and an inspector main body 47.

The receiver 40 has a function of receiving signals of various types via the internet line 7. The detector 41 has a function of detecting whether or not the signals of various types are received in the receiver 40. The data processor 42 has a function of generating a signal to be transmitted via the internet line 7, a function of retrieving various data from a signal received via the internet line 7 and a function of executing various signal processes to the data. The inspector 43 is adapted to realize a device configuration of the terminal device 2 on the software and execute a program on the realized device configuration and has a function of reproducing a materialization state of the information contents using the program in the terminal device 2 based on the program and device information and inspecting a reproduction state thereof. The transmitter 44 has a function of transmitting the signal generated in the data processor 42.

The respective components of the inspector 43 function in the following manner so that the described functions are exerted in the inspector 43. The device configuration generating section 45 generates data for reproducing the device configuration of the terminal device 2 based on the device information of the terminal device 2. The inspection pattern generating section 46 generates a program operation pattern used in materializing the information contents, which the user desires to materialize, using an optional program (software). The program operation pattern is generated based on program data of the program. The inspector main body 47 reproduces the materialization state of the information contents using the program in the terminal device 2 and inspects the reproduction state thereof. In doing so, the inspection is carried out based on device configuration reproduction data of the terminal device 2 generated by the device configuration generating section 45 and the program operation pattern generated by the inspection pattern generating section 46.

The settlement management device 6 comprises, as shown in FIG. 6, a receiver 50, a data processor 51, a terminal device fund data storing unit 52, a contents distribution device fund data storing unit 53, a program distribution device fund data storing unit 54 and an inspection device fund data storing unit 55. The receiver 50 receives a signal including charge information from the contents distribution device 3 via the internet line 7. The data processor 51 reads the charge information from the signal received from the contents distribution device 3 and executes various signal processes to the information. The terminal device fund data storing unit 52 is supplied with fund data of the terminal device 2. The contents distribution device fund data storing unit 53 is supplied with fund data of the contents distribution device 3. The program distribution device fund data storing unit 54 is supplied with fund data of the program distribution device 4. The inspection device fund data storing unit 55 is supplied with fund data of the inspection device 5. The terminal device fund data storing unit 52 is previously supplied with the fund data by the user of the terminal device 2 in order to operate the download system 1 and executes a charge operation.

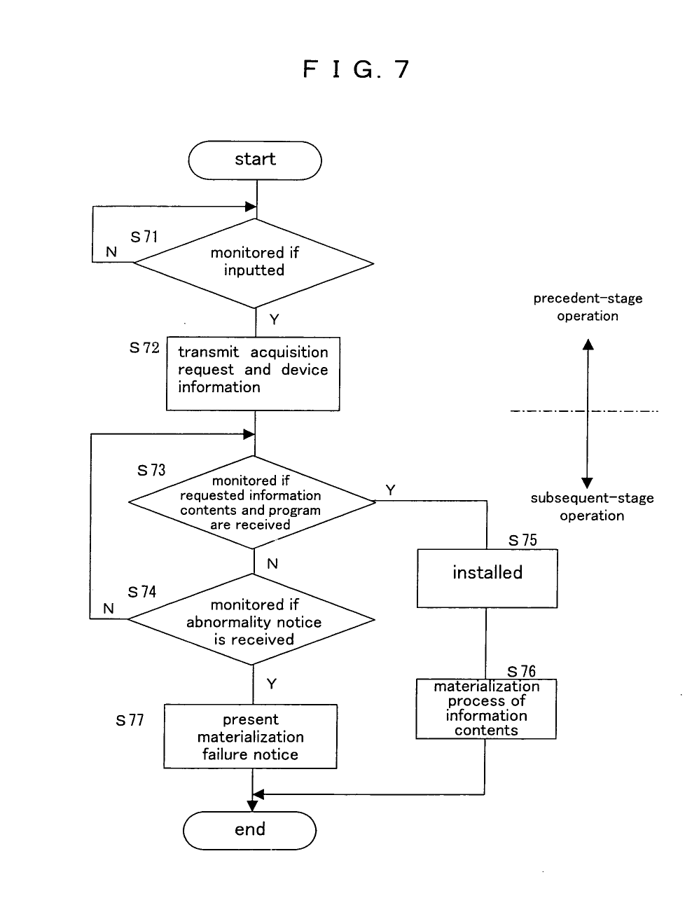

Hereinafter, operations of transmitting/receiving the information contents by the download system 1 are described referring to flow charts of FIGS. 7 through 10.

First, an operation of the terminal device 2 is described referring to the flow chart of FIG. 7.

In the optional terminal device 2, it is monitored whether or not the user of the terminal device 2 carries out the instruction input operation to the input unit 10 (S71). In the instruction input operation, information designating information contents, which the user desires to download, is inputted. When it is confirmed that the instruction input operation is carried out in the S71, in the data processor 14, the information contents desired by the user is identified based on the inputted data, and then, a request for acquiring the desired information contents is generated. Further, in the data processor 14, the device information of the terminal device 2 is read from the device information storing unit 15 and attached to the acquisition request. The acquisition request with the device information is transmitted to the transmitter 11. In the transmitter 11, the acquisition request and the device information transmitted from the data processor 14 are transmitted to the contents distribution device 3 via the internet line 7 (S72).

So far was described a precedent-stage operation of the terminal device 2 (operation relating to the output of the acquisition request).

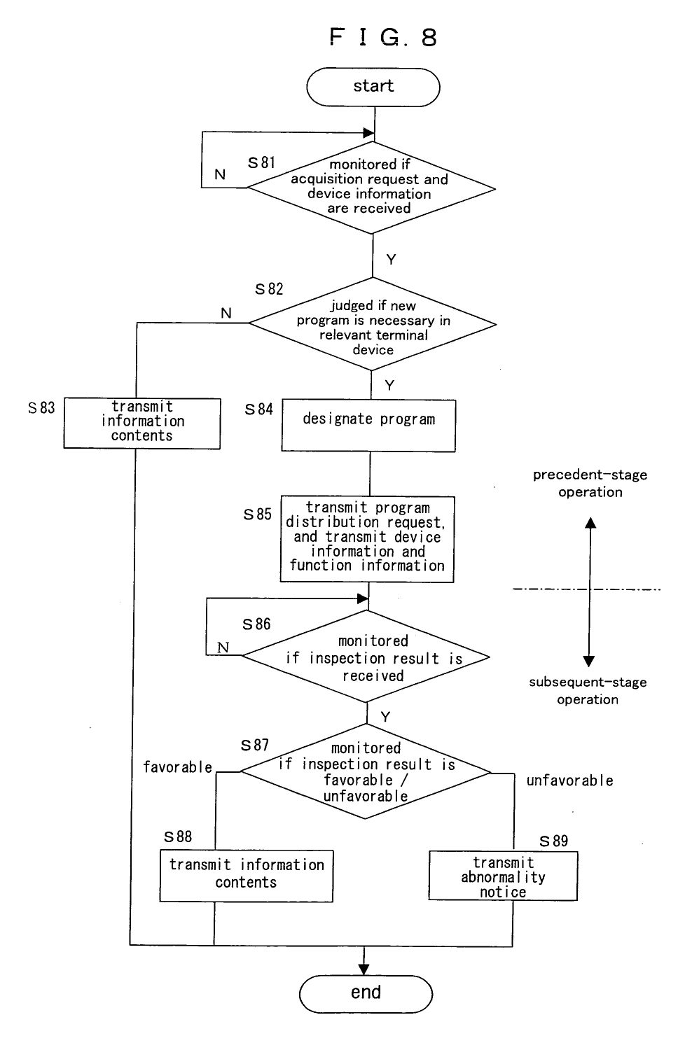

Next, a precedent-stage operation of the contents distribution device 3 for receiving the acquisition request from the terminal device 2 is described referring to FIG. 8. In the contents distribution device 3, it is monitored whether or not the acquisition request and the device information are received from the terminal device 2 via the internet line 7 (S81) by the detector 21. When it is detected in the S81 that the acquisition request and the device information are received, the data processor 22 transmits the received acquisition request to the designator 23. The designator 23 judges whether or not a new program for realizing a function for materializing the information contents in the terminal device 2 transmitting the acquisition is necessary based on the information contents requested in the received acquisition request and the device information attached to the acquisition request (S82).

When the new program is judged to be unnecessary in the S82, the data processor 32 reads the information contents requested in the received acquisition request (desired by the terminal device 2) from the contents storing unit 24 and transmits the read information contents to the transmitter 25. The transmitter 25 generates a signal including the information contents and transmits the signal to the terminal device 2 (S82). Then, a sequence of processes is terminated.

When the new program is judged to be necessary in the S82, the data processor 32 identifies a function required for materializing the information contents desired by the terminal device 2 transmitting the acquisition request based on the received acquisition request and the device information. Further, the designator 23 designates a program required for realizing the function in the terminal device 2 (S84).

As examples of the information contents can be mentioned image data recorded in an image recording format of MPEG4 and audio data recorded in au audio recording format of MP3. As an example of the function can be mentioned a function required for reproducing the image data and the audio data (MPEG4 reproduction function and MP3 reproduction function), which can be identified based on the information contents and the device configuration of the terminal device 2. Further, a program required for realizing the identified function is identified. The respective terminal devices 2 require the different functions and programs (particularly, program) because the constitution, processing performance and the like of the executor 17 are different in each terminal device 2.

When the program is designated by the designator 23 in the S84, a request for distributing the program is generated in the data processor 22 and transmitted to the transmitter 25. The transmitter 25, in response to the receipt of the distribution request, generates a signal including the distribution request and transmits the signal to the program distribution device 4. At that time, the data processor 22 immediately generates an instruction for transmitting the device information of the terminal device 2 requiring the program and information representing the function (program) required by the terminal device 2 (function information) and transmits the instruction to the transmitter 25. The transmitter 25 transmits a signal including the device information and the function information to the inspection device 5 based on the instruction (S85).

So far was described the precedent-stage operation of the contents distribution device 3 (operation relating to the output of the distribution request).

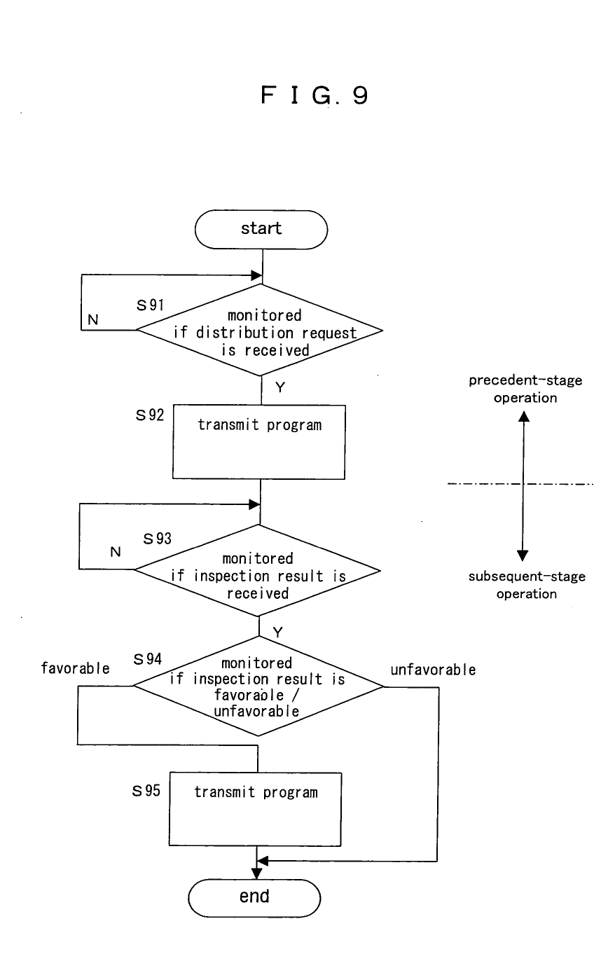

Next, a precedent-stage operation of the program distribution device 4 for receiving the distribution request from the contents distribution device 3 is described referring to FIG. 9.

It is monitored in the program distribution device 4 whether or not the distribution request is received from the contents distribution device 3 via the internet line 7 (S91) by the detector 31. When it is detected in the S91 that the distribution request is received, the data processor 32, the program designated in the received distribution request is read from the program string unit 33. Further, the data processor 32 transmits the read program to the transmitter 34. The transmitter 34 generates a signal including the transmitted program and transmits the signal to the inspection device 5 (S92).

The precedent-stage operation of the program distribution device 4 (operation relating to the output of the program) was described above.

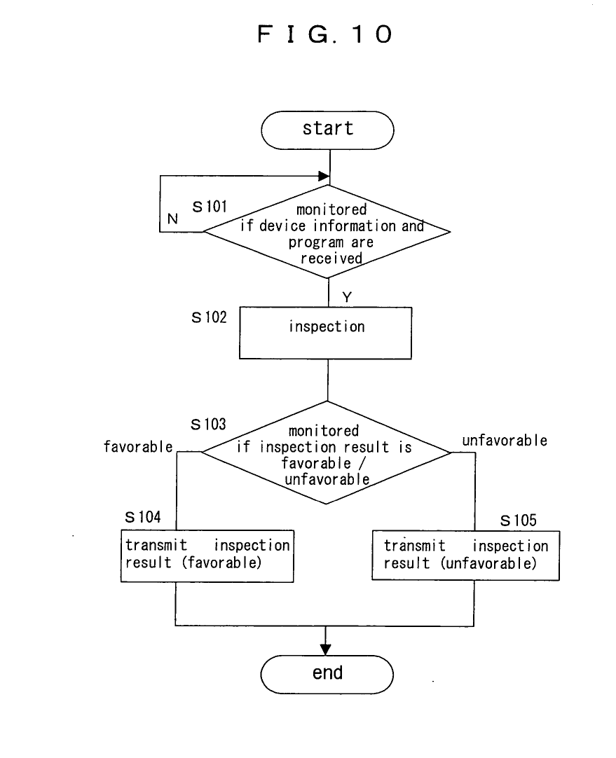

Next, an operation of the inspection device 5 for receiving the device information from the contents distribution device 3 and receiving the program from the program distribution device 4 is described referring to FIG. 10.

In the inspection device 5, it is continuously monitored whether or not the signal including the device information and the function information is received from the contents distribution device 3 via the internet line 7 and whether or not the signal including the program is received from the program distribution device 4 (S101) by the detector 41. Upon detecting the reception of the monitored signals in the S101, in the data processor 42, the program, device information and function information are extracted from the received signals, which are then transmitted to the inspector 43. In the inspector 43, a virtual device configuration of the terminal device 2 desiring the program is generated from the transmitted device information in the device configuration generating section 45. Further, an inspection pattern is generated from the transmitted device information and function information in the inspection pattern generating section 46. Further, in the inspector main body 47, the device configuration of the terminal device 2 is realized on the software based on the generated device configuration and inspection pattern. Then, the materialization state of the information contents using the program is reproduced on the realized device configuration and the reproduction state thereof is inspected (S102).

The information contents used in the inspection in the S102 are sample contents having an example of a general format of the information contents, and the sample contents are generated in the inspection pattern generating section 46.

In the inspector main body 47, it is judged if a result of the implemented inspection obtained in the S102 (inspection result) is favorable or unfavorable (S103), and a signal including the inspection result (favorable/unfavorable) is transmitted to the contents distribution device 3 and the program distribution device 4 from the transmitter 44 (S104 and S105). Then, a sequence of processes of the inspection device 5 is terminated.

Next, an operation (subsequent stage) of the program distribution device 4 after the program is transmitted in the S92 is described referring to FIG. 9.

In the inspector 31, it is monitored whether or not the signal including the inspection result is received from the inspection device 5 (S93). When the reception of the signal including the inspection result is confirmed in the S93, it is judged if the inspection result is favorable or unfavorable in the data processor 32 (S94). When the inspection result is judged to be favorable in the S94, the data processor 32 reads a program required for materializing the information contents desired by the terminal device 2 from the program storing unit 33 and transmits the program to the transmitter 34. The transmitter 34 generates a signal including the program and transmits the signal to the terminal device 2 (S95). The distribution request received in the S91 is previously memorized in the data processor 32 and the like, and the program transmitted in the S95 is identified based on the previously memorized distribution request.

When the inspection result is judged to be unfavorable in the S94, there is no transmission of the program, and a sequence of processes of the program distribution device 4 is terminated.

Next, an operation (subsequent stage) of the contents distribution device 3 after the distribution request and the device information are transmitted in the S85 is described referring to FIG. 8. In the inspector 21, it is monitored whether or not the signal including the inspection result is received (S86). When the reception of the signal including the inspection result is confirmed in the S86, the data processor 22 judges if the inspection result is favorable or unfavorable (S87). When the inspection result is judged to be favorable in the S87, the data processor 22 reads the information contents requested in the received acquisition request (desired by the terminal device 2) from the contents storing unit 24 and transmits the read information contents to the transmitter 25. The transmitter 25 generates a signal including the information contents and transmits the signal to the terminal device 2 (S88)

The acquisition request received in the S81 is previously memorized in the data processor 22 and the like, and the information contents transmitted in the S88 are identified based on the previously memorized acquisition request.

When the inspection result is judged to be unfavorable in the S87, the data processor 22 judges that an abnormality is generated if the information contents desired by the terminal device 2 are materialized in the terminal device 2, and generates a notice for notifying the abnormality and transmits the notice to the transmitter 25. The transmitter 25 generates a signal including the abnormality notice and transmits the signal to the terminal device 2 (S89).

In the contents distribution device 3, a sequence of processes is terminated when the transmission of the program is completed (S88) or the transmission of the abnormality notice is completed (S89).

Next, an operation of the terminal device 2 after the information contents acquisition request and the device information are transmitted in the S72 is described referring to FIG. 7.

After the acquisition request and the device information are transmitted in the S72, the terminal device 2 monitors the receptions (S73 and S74). More specifically, in the terminal device 2, it is monitored whether or not the desired information contents are received from the contents distribution device 3 and whether or not the program required for materializing the information contents (image display process and sound production process in the executor 17) is received from the program distribution device 4 (S73), and further, it is monitored whether or not the abnormality notice is received from the contents distribution device 3 (S74), and these are monitored by the detector 13.

The data processor 14 notified of the reception of the information contents and the program by the detector 13 in the S73 installs the received program in the executor 17 (S75). The received program is smoothly installed because the contents distribution device 3, and the inspection device 5 have already confirmed that the installation of the program in the executor 17 does not cause any problem.

Further, in the data processor 14, the received information contents are materialized in the presenter 16 (display process sound production process) (S76). The materialization process is executed by means of a function exerted by the installed program. The materialization process for the information contents can be smoothly executed in the data processor 14 by means of the program because the inspection device 5 has already confirmed that the execution of the process does not cause any problem.

The data processor 14 notified of the reception of the abnormality notice by the detector 13 in the S74 presents a notice indicating that the materialization (image display process and sound production process) of the information contents desired by the user is not possible in the presenter 16 (S77). The user of the terminal device 2 notified of the presented materialization failure acknowledges that the desired information contents cannot be materialized according to the device configuration of the terminal device 2 and resigns the acquisition of the information contents.

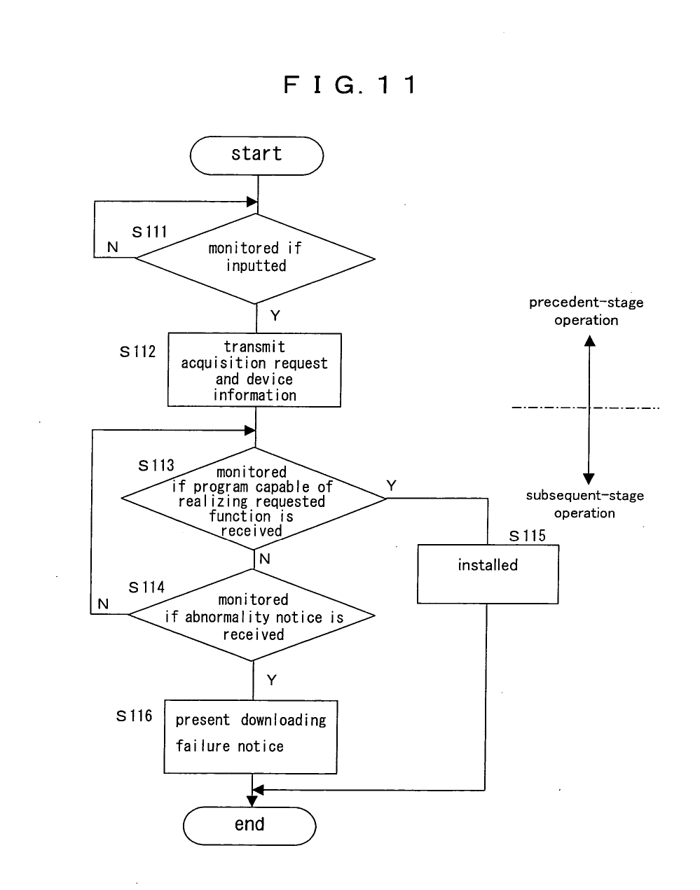

So far were described the processes executed when the download system 1 functions as the information contents download system. Next, operations of transmitting/receiving a function program in the case of the download system 1 functioning as the function download system are described referring to flow charts of FIGS. 11 through 14. In this case, the contents distribution device 3 functions as a distribution management device.

First, an operation of the terminal device 2 is described referring to the flow chart of FIG. 11.

In the optional terminal device 2, it is monitored whether or not the user of the terminal device 2 carries out the instruction input operation to the input unit 10 (S111). In the instruction input operation, information designating a function which the user desires to download is inputted. When it is confirmed that the instruction input operation is carried out in the S111, the function desired by the user is identified based on the inputted data, and then, a request for acquiring the desired function is generated in the data processor 14. Further, in the data processor 14, the device information of the terminal device 2 is read from the device information storing unit 15 and attached to the acquisition request. The acquisition request with the device information is transmitted to the transmitter 11. In the transmitter 11, the acquisition request and the device information transmitted from the data processor 14 are transmitted to the contents distribution device 3 via the internet line 7 (S112).

So far was described a precedent-stage operation of the terminal device 2 (process relating to the output of the acquisition request).

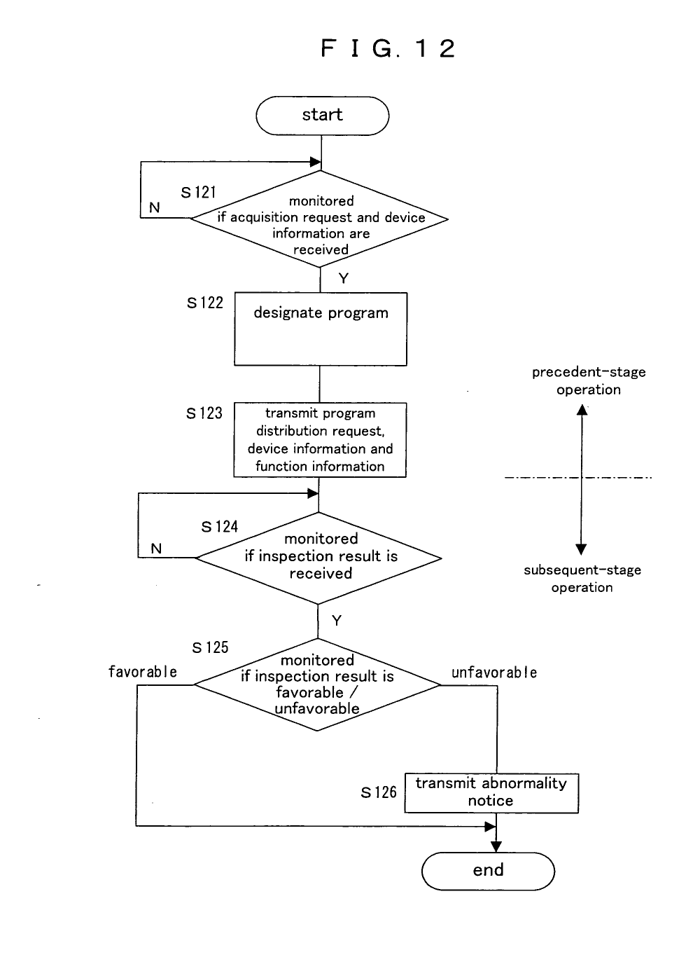

Next, a precedent-stage operation of the contents distribution device 3 for receiving the acquisition request from the terminal device 2 is described referring to FIG. 12. In the contents distribution device 3, it is monitored whether or not the acquisition request and the device information are received from the terminal device 2 via the internet line 7 (S121) by the detector 21. When the reception of the acquisition request and the device information are detected in the S121, the data processor 22 transmits the received acquisition request to the designator 23. The designator 23 designates a program required for realizing the desired function in the terminal device 2 transmitting the acquisition request based on the received acquisition request and device information (S122).

As examples of the function can be mentioned the MPEG4 reproduction function and MP3 audio data reproduction function, and programs required for realizing the functions in the terminal device 2 are designated based on these functions. The respective terminal devices 2 each demands a different program due to the differences in the constitutions, processing performances and the like of the executors 17 thereof.

When the program is designated by the designator 23 in the S122, a request for distributing the program is generated in the data processor 22 and transmitted to the transmitter 25. The transmitter 25, in response to the receipt of the distribution request, generates a signal including the distribution request and transmits the signal to the program distribution device 4 (S123). At that time, the data processor 22 immediately generates an instruction for transmitting the device information of the terminal device 2 demanding the function (program) and information representing the function demanded by the terminal device 2 (function information) and transmits the instruction to the transmitter 25. The transmitter 25 transmits a signal including the device information and the function information to the inspection device 5 based on the instruction.

So far was described the precedent-stage operation of the contents distribution device 3 (process relating to the output of the distribution request).

Next, a precedent-stage operation of the program distribution device 4 for receiving the distribution request from the contents distribution device 3 is described referring to FIG. 9.

It is monitored in the program distribution device 4 whether or not the distribution request is received from the contents distribution device 3 via the internet line 7 (S131) by the detector 31. When it is detected in the S131 that the distribution request is received, the data processor 32 reads the program designated in the received distribution request from the program string unit 33. Further, the data processor 32 transmits the read program to the transmitter 34. The transmitter 35 generates a signal including the transmitted program and transmits the signal to the inspection device 5 (S132).

The precedent-stage operation of the program distribution device 4 (process relating to the output of the program) was described above.

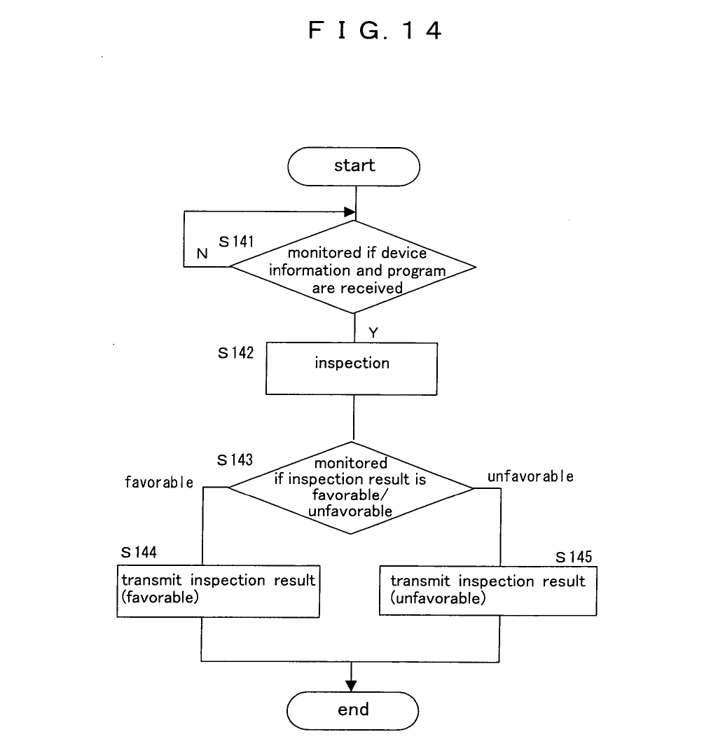

Next, an operation of the inspection device 5 for receiving the device information from the contents distribution device 3 and receiving the program from the program distribution device 4 is described referring to FIG. 14.

In the inspection device 5, it is continuously monitored whether or not the signal including the device information and the function information is received from the contents distribution device 3 via the internet line 7 and whether or not the signal including the program is received from the program distribution device 4 (S141) by detector 41. Upon detecting the reception of the monitored signals in the S141, the data processor 42 extracts the device information and the function information from the received signals and transmits these informations to the inspector 43. In the inspector 43, a virtual device configuration of the terminal device 2 desiring the program is generated in the device configuration generating section 45 from the transmitted device information. Further, an inspection pattern is generated from the transmitted device information and function information in the program inspection pattern generating section 46. Further, in the inspector main body 47, the device configuration of the terminal device 2 is realized on the software based on the generated device configuration and inspection pattern. Then, the materialization state of the information contents using the program is reproduced on the realized device configuration, and the reproduction state thereof is inspected. (S142).

The inspection of the S142 requires the information contents to which the function program is executed. The information contents used in the inspection are sample contents having an example of a general format of the information contents, and the sample contents are generated in the inspection pattern generating section 46.

In the inspector main body 47, it is judged if a result of the implemented inspection obtained in the S142 (inspection result) is favorable or unfavorable (S143), and a signal including the inspection result (favorable/unfavorable) is transmitted to the contents distribution device 3 and the program distribution device 4 from the transmitter 44 (S144 and S145). Then, a sequence of processes of the inspection device 5 is terminated.

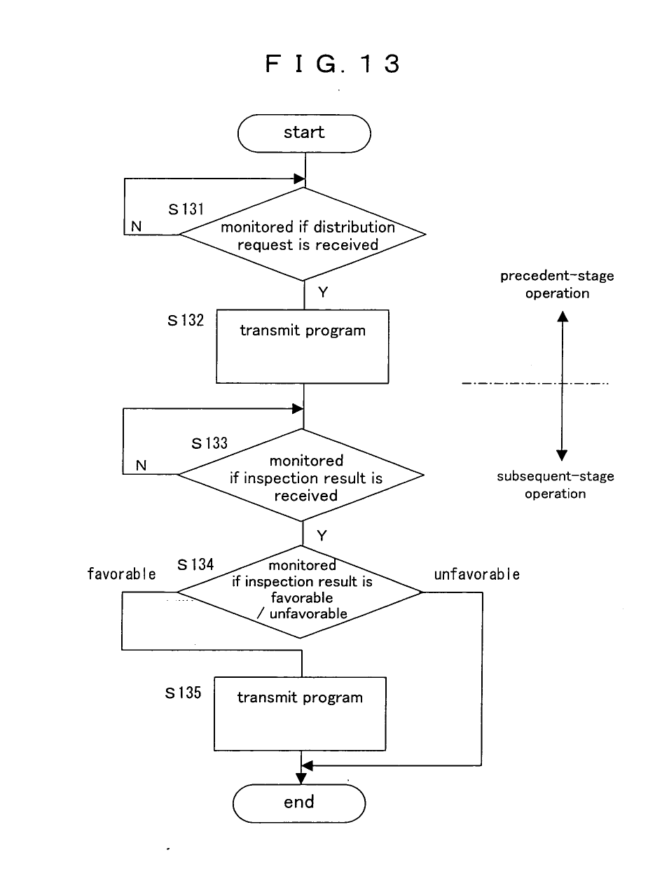

Next, an operation (subsequent stage) of the program distribution device 4 after the program is transmitted in the S132 is described referring to FIG. 13.

In the inspector 31, it is monitored whether or not the signal including the inspection result is received from the inspection device 5 (S133). When the reception of the signal including the inspection result is confirmed in the S133, it is judged if the inspection result is favorable or unfavorable in the data processor 32 (S134). When the inspection result is judged to be favorable in the S134, the data processor 32 reads a program required for materializing the function desired by the terminal device 2 from the program storing unit 33 and transmits the program to the transmitter 34. The transmitter 34 generates a signal including the program and transmits the signal to the terminal device 2. The received distribution request is previously memorized in the data processor 32 and the like, and the program transmitted in the S135 is identified based on the previously memorized distribution request.

When the inspection result is judged to be unfavorable in the S134, the program is not transmitted, and a sequence of processes in the program distribution device 4 is terminated.

Next, an operation (subsequent stage) of the contents distribution device 3 after the distribution request, device information and function information are transmitted in the S123 is described referring to FIG. 12.

In the inspector 21, it is monitored whether or not the signal including the inspection result is received from the inspection device 5 (S124). When the reception of the signal including the inspection result is confirmed in the S124, it is judged if the inspection result is favorable or unfavorable in the data processor 22 (S125). When the inspection result is judged to be favorable in the S125, a sequence of processes is terminated in the data processor 22.

When the inspection result is judged to be unfavorable in the S125, the data processor 22 judges that an abnormality is generated if the function desired by the terminal device 2 is realized in the terminal device 2, and generates a notice of notifying the probable abnormality and transmits the abnormality notice to the transmitter 25. The transmitter 25 generates a signal including the abnormality notice and transmits the signal to the terminal device 2 (S126). A sequence of processes is terminated when the transmission of the abnormality notice is completed (S126).

Next, an operation of the terminal device 2 after the function acquisition request and the device information are transmitted in the S112 is described referring to FIG. 11.

After the acquisition request and the device information are transmitted in the S112, the terminal device 2 monitors the reception (S113 and S114). More specifically, in the terminal device 2, it is monitored whether or not the program for realizing the desired function is received from the program distribution device 4 (S113), and whether or not the abnormality notice is received from the contents distribution device 3 (S114) by the detector 13.

The data processor 14 notified of the reception of the program by the detector 13 in the S113 installs the received program in the executor 17 (S115). The received program is smoothly installed and operated in the executor 17 of the terminal-device 2 because the inspection device 5 has already confirmed that the received program can be installed in the executor 17 and can be operated in the terminal device 2 without generating any problem.

The data processor 14 notified of the reception of the abnormality notice by the detector 13 in the S114 presents a notice indicating that the function desired by the user cannot be realized in the terminal device 2 (image display process and sound production process) (S116). The user of the terminal device 2 notified of the presented materialization failure acknowledges that the desired function cannot be realized according to the device configuration of the terminal device 2 and resigns the acquisition of the function.

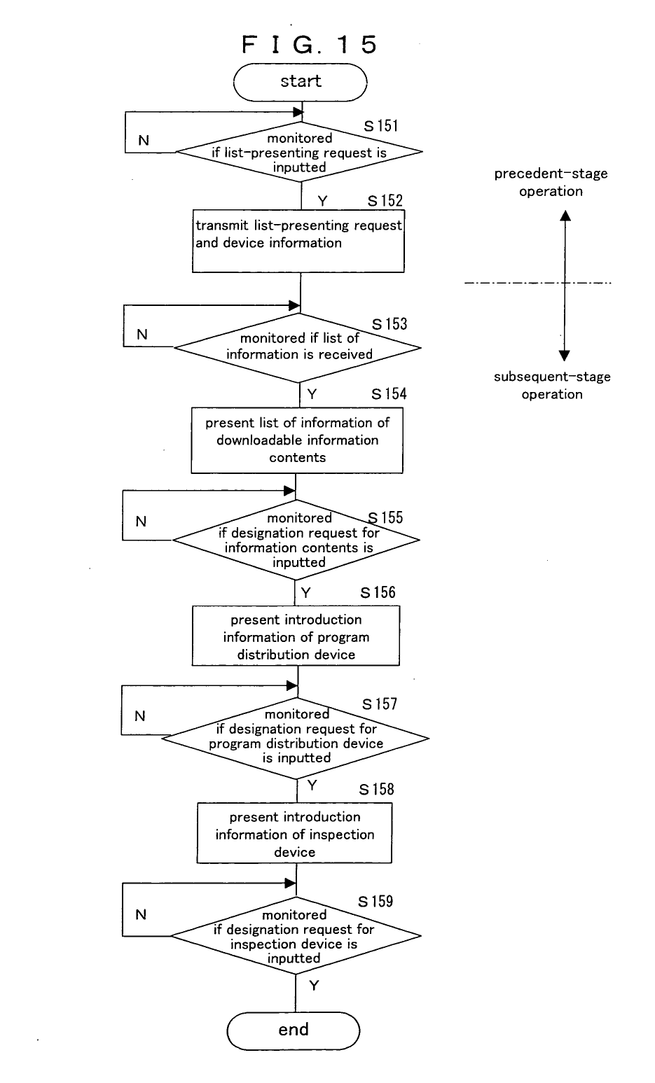

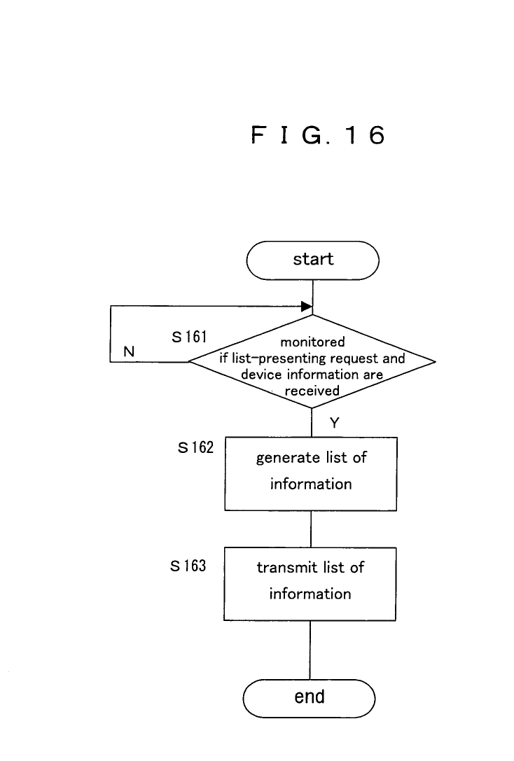

Next is described a case in which the download system 1 is operated as the information contents download system under the following conditions is described referring to flow charts of FIGS. 15 and 16.

There are a plurality of downloadable information contents and functions in the terminal device 2.

There is a plurality of program distribution devices 4, each comprising a program capable of realizing a same function while having a different constitution.

There is a plurality of inspection devices 5 capable of performing a same inspection.

First, an operation of the terminal device 2 is described referring to the flow chart of FIG. 15. The operation described below is carried out as a process prior to the S111 in the flow chart of FIG. 11.

In the terminal device 2, it is monitored whether or not the user of the terminal device 2 inputs a request for presenting a list to the input unit 10 (S151). The request for the list indicates a request for downloading a list of information relating to the information contents, which are downloadable into the terminal device 2, from the contents distribution device 3. When the input of the request for presenting the list is confirmed in the S151, a request for presenting the list is generated in the data processor 14. Further, in the data processor 14, the device information of the terminal device 2 is read from the device information storing unit 15 and attached to the list-presenting request. The list-presenting request with the device information is transmitted to the transmitter 11. The transmitter 11 transmits the list-presenting request and the device information transmitted from the data processor 14 to the contents distribution device 3 via the internet line 7 (S152)

So far was described a precedent-stage operation of the terminal device 2 (process relating to the output of the list-presenting request).

Next, an operation of the contents distribution device 3 for receiving the list-presenting request from the terminal device 2 is described referring to the flow chart of FIG. 16. In the contents distribution device 3, it is monitored whether or not the list-presenting request and the device information are received from the terminal device 2 via the internet line 7 (S161) by the detector 21. When the reception of the list-presenting request and the device information is detected in the S161, the data processor 22 transmits the received list-presenting request to the designator 23. The designator 23 designates the information contents that can be materialized in the terminal device 2 transmitting the list-presenting request and the function required for materializing the information contents in the terminal device 2 based on the received list-presenting request and device information. Further, in the designator 23, it is judged whether or not a new program is necessary for realizing the function in the terminal device 2. When the new program is judged to be necessary, the program distribution device 4 providing the program for realizing the function in the terminal device 2 is designated. When the program and the distribution device 4 capable of providing the program are designated, the inspection device 5 capable of inspecting the program is designated. In this case, more than one program distribution device 4 and inspection device 5 may be designated. In fact, a plurality of program distribution devices 4 and inspection devices 5 are generally designated. In the designator 23, the list of information including the various designation requests described above is generated (S162).

A signal including the list of information generated in the S162 is transmitted from the transmitter 25 to the terminal device 2 via the data processor 22 (S163).

Next, an operation (subsequent stage) of the terminal device 2 after the list-presenting request and the device information are transmitted in the S152 is described referring to FIG. 15.

After the list-presenting request and the device information are transmitted in the S152, it is monitored whether or not the list of information is received in the terminal device 2 by the detector 13 (S153).

In the data processor 14 notified of the reception of the list of information by the detector 13 in the S153, a list of information of the information contents is read from the received list of information. The list of information of the information contents refers to information indicating a list of a singular or a plurality of information contents that can be materialized in the terminal device 2. The read list of information of the information contents is presented in the presenter 16 (display process, sound production process and the like (S154).

After the presentation of the list of the information contents, it is monitored whether or not the user inputs a request for designating the desired information contents to the input unit 10 in the data processor 14 (S155).

The data processor 14, as a result of confirming the input of the information contents designation request in the S155, memorizes the designation request for the designated desired information contents, and further, reads introduction information of the program distribution device 4 from the received list of information. The introduction information of the program distribution device 4 refers to information representing a list of at least a program distribution device 4 for distributing the program for realizing the function required for materializing the designated information contents in the terminal device 2. The presentation process is executed to the read introduction information of the program distribution device 4 in the presenter 16 (display process, sound production process and the like) (S156).

After the presentation process is executed to the introduction information of the program distribution device 4, it is monitored whether or not the user inputs the designation request of the program distribution device 4 to the input unit 10 in the data processor 14 (S157).

In the data processor 14, subsequent to the confirmation of the inputted designation request of the program distribution device 4 in the S157, the designation request of the designated program distribution device 4 is memorized, and further, introduction information of the inspection device 5 is read from the received list of information. The introduction information of the inspection device 5 refers to information representing a list of at least an inspection device 5 provided with a function of inspecting whether or not the program distributed by the designated program distribution device 4 is successfully operated in the terminal device 2. The read introduction information of the inspection device 5 is subjected to the presentation process in the presenter 16 (display process, sound production process and the like) (S158).

After the execution of the presentation process to the introduction information of the inspection device 5, in the data processor 14, it is monitored whether or not the user inputs a request for designating the inspection device 5 to the input unit 10 (S159). The data processor 14 detects the input of the designation request for the inspection device 5 and memorizes the designation request for the designated inspection device 5. Further, the data processor 14 generates a request for acquiring the information contents based on the memorized designation request for the information contents, designation request for the program distribution device 4 and designation request for the inspection device 5, and transmits the generated acquisition request for the information contents and the device information of the terminal device 2 to the contents distribution device 3. The transmission process corresponds to the S72 in FIG. 7, and processes thereafter correspond to the S73 and the following steps in FIG. 7.

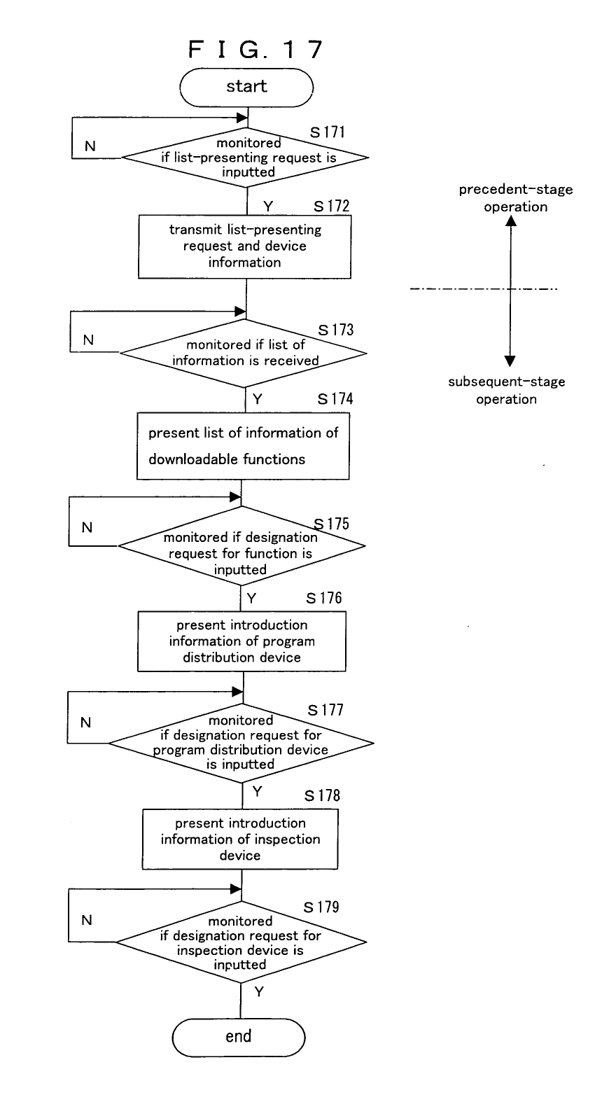

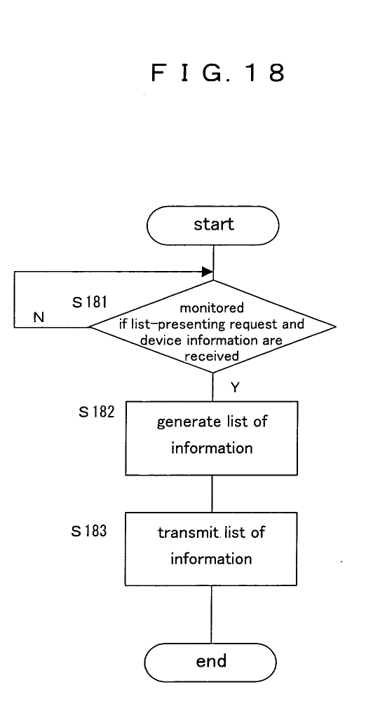

Next is described a case in which the download system 1 is operated as the function download system under the following conditions is described referring to flow charts of FIGS. 17 and 18.

In the configuration for downloading the function:
There is a plurality of downloadable functions in the terminal device;
There is a plurality of program distribution devices 4, each comprising a program capable of realizing a same function while having a different constitution; and
There is a plurality of inspection devices 5 capable of performing a same inspection.

First, an operation of the terminal device 2 is described referring to the flowchart of FIG. 17. The operation described below is carried out as a process prior to the S111 in the flow chart of FIG. 11 in the same manner as in the flow chart of FIG. 15.

In the terminal device 2, it is monitored whether or not the user of the terminal device 2 inputs a request for presenting a list to the input unit 10 (S171). The request for the list presentation indicates a request for downloading a list of information relating to the functions downloadable in the terminal device 2 from the contents distribution device 3. When the input of the request for the list presentation is confirmed in the S171, a request for presenting the list is generated in the data processor 14. Further, in the data processor 14, the device information of the terminal device 2 is read from the device information storing unit 15 and attached to the list-presenting request. The list-presenting request with the device information is transmitted to the transmitter 11. The transmitter 11 transmits the list-presenting request and the device information transmitted from the data processor 14 to the contents distribution device 3 via the internet line 7 (S172).

So far was described a precedent-stage operation of the terminal device 2 (process relating to the output of the list-presenting request).

Next, an operation of the contents distribution device 3 for receiving the list-presenting request from the terminal device 2 is described referring to the flow chart of FIG. 18. In the contents distribution device 3, it is monitored whether or not the list-presenting request and the device information are received from the terminal device 2 via the internet line 7 (S181) by the detector 21. When the reception of the list-presenting request and the device information is detected in the S181, the data processor 22 transmits the received list-presenting request to the designator 23. The designator 23 designates the function which can be materialized in the terminal device 2 transmitting the list-presenting request based on the received list-presenting request and device information. Further, in the designator 23, the program distribution device 4 capable of providing the program for realizing the function in the terminal device 2 is designated. When the program and the program distribution device 4 providing the program are designated, the inspection device 5 capable of inspecting the program is designated. In this case, more than one program distribution device 4 and inspection device 5 may be designated. In fact, a plurality of program distribution devices 4 and inspection devices 5 are generally designated. In the designator 23, the list of information including the various designation requests described above is generated (S182).

A signal including the list of information generated in the S182 is transmitted from the transmitter 25 to the terminal device 2 via the data processor 22 (S183).

Next, an operation (subsequent stage) of the terminal device 2 after the list-presenting request and the device information are transmitted in S172 is described referring to FIG. 17.

After the list-presenting request and the device information are transmitted in the S172, it is monitored whether or not the list of information is received in the terminal device 2 by the detector 13 (S173).

In the data processor 14 notified of the reception of the list of information by the detector 13 in the S173, a list of information of the functions is read from the received list of information. The list of information of the functions refers to information indicating a list of a singular or a plurality of functions which can be materialized in the terminal device 2. The read list of information of the functions is subjected to the presentation process in the presenter 16 (display process, sound production process and the like (S174).

After the presentation of the list of the functions, it is monitored whether or not the user inputs a request for designating the desired function to the input unit 10 in the data processor 14 (S175).

The data processor 14, as a result of confirming the input of the function designation request in the S175, memorizes the inputted function designation request, and further, reads introduction information of the program distribution device 4 from the received list of information. The introduction information of the program distribution device 4 refers to information representing a list of at least a program distribution device 4 capable of distributing the program required for realizing the designated function in the terminal device 2. The read introduction information of the program distribution device 4 is subjected to the presentation process in the presenter 16 (display process, sound production process and the like) (S176).

After the introduction information of the program distribution device 4 is presented, it is monitored whether or not the user inputs the designation request for the program distribution device 4 to the input unit 10 in the data processor 14 (S177).

In the data processor 14, subsequent to the confirmation of the inputted designation request for the program distribution device 4 in the S177, the inputted designation request for the program distribution device 4 is memorized, and further, introduction information of the inspection device 5 is read from the received list of information. The introduction information of the inspection device 5 refers to information representing a list of at least an inspection device 5 provided with a function of inspecting whether or not the program distributed by the designated program distribution device 4 is successfully operated in the terminal device 2. The read introduction information of the inspection device 5 is subjected to the presentation process in the presenter 16 (display process, sound production process and the like) (S178).

After the execution of the presentation process to the introduction information of the inspection device 5, in the data processor 14, it is monitored whether or not the user inputs a request for designating the inspection device 5 to the input unit 10 (S179). The data processor 14 detects the input of the designation request for the inspection device 5 and memorizes the inputted designation request for the inspection device 5. Further, the data processor 14 generates a request for acquiring the function based on the memorized designation request for the function, designation request for the program distribution device 4 and designation request for the inspection device 5, and transmits the generated function acquisition request and the device information of the terminal device 2 to the contents distribution device 3. The transmission process corresponds to the S112 in FIG. 11, and processes thereafter correspond to the S113 and the following steps in FIG. 11.

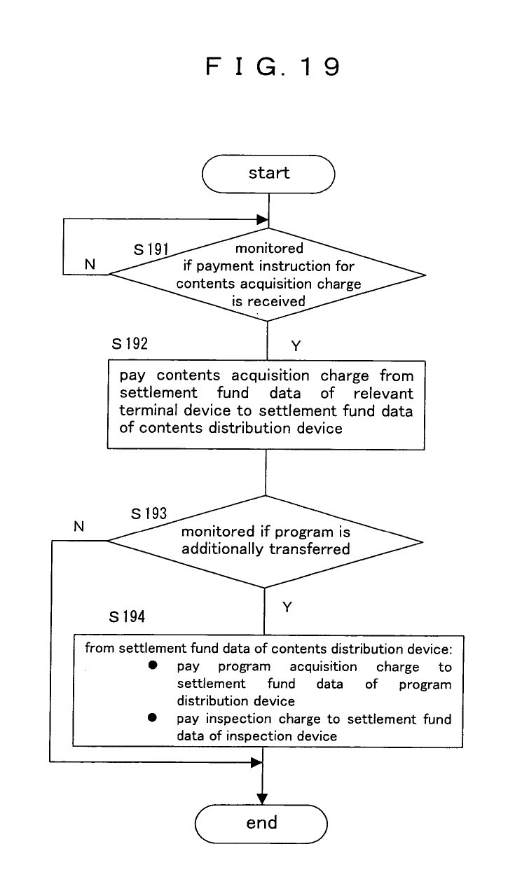

Next, a charging system and a method of implementing the system in the download system 1 are described referring to flow charts of FIGS. 6, 19 and 20. First, the charging system and its processes in the case of the transmission/reception of the information contents in the download system 1 are described. In FIG. 6, black arrows show a flow of instruction information, while white arrows show a flow of money data.

The terminal device 2 transmits an instruction for paying a contents acquisition charge to the settlement management device 6 in response to the acquisition of the information contents from the contents distribution device 3. When the payment instruction is transmitted, ID information of the terminal device 2 is preferably set in advance between the terminal device 2 and the settlement management device 6 so that the ID information is memorized in the terminal device 2 and the settlement management device 6. Thereby, the settlement management device 6 can identify the terminal device 2 which transmitted the payment instruction by attaching the ID information to the payment instruction transmitted from the terminal device 2. In this manner, it can be inhibited that any false terminal device 2 transmits the payment instruction.

In the settlement management device 6, it is monitored whether or not the payment instruction is received from the terminal device 2 (S191) by the data processor 51.

The data processor 51 confirms the reception of the payment instruction from the terminal device 2 in the S191, and outputs the payment instruction for the contents acquisition charge to the terminal device fund data storing unit 52. The terminal device fund data storing unit 52 receives the payment instruction for the contents acquisition charge and executes a data process for retrieving the contents acquisition charge from settlement fund data of the terminal device 2 stored therein. More specifically, the data process for subtracting money data corresponding to the contents acquisition charge from the settlement fund data is executed.

The data processor 51 confirms the execution of the data process for retrieving the contents acquisition charge in the terminal device fund data storing unit 52 and outputs an instruction for receiving the contents acquisition charge to the contents distribution device fund data storing unit 53. The contents distribution device fund data storing unit 53 receives the receipt instruction for the contents acquisition charge and executes a data process for receiving the contents acquisition charge to settlement fund data of the contents distribution device 3 stored therein. More specifically, the data process for adding the money data corresponding to the contents acquisition charge to the settlement fund data is executed (S192).

The data processor 51 confirms the execution of the data process for receiving the contents acquisition charge in the contents distribution device fund data storing unit 53 and judges whether or not the current transfer of the information contents accompanies the transfer of the function program (S193) The judgment is made by, for example, analyzing the contents payment instruction received from the terminal device 2.

The data processor 51 terminates a sequence of payment processes when judging that the transfer of the function program is not additionally generated.

On the contrary, when it is judged that the transfer of the function program is additionally generated in the S193, in the data processor 51, an instruction for paying a program acquisition charge and an instruction for paying an inspection charge are outputted to the contents distribution device fund data storing unit 53. The contents distribution device fund data storing unit 53 receives these instructions and executes data processes for retrieving the program acquisition charge and the inspection charge from the stored settlement fund data of the contents distribution device 3. More specifically, the data process for subtracting money data corresponding to the program acquisition charge from the stored settlement fund data of the contents distribution device 3 and the data process for subtracting money data corresponding to the inspection charge are executed.

The data processor 51 confirms the execution of the data processes for retrieving the program acquisition charge and the inspection charge in the contents distribution device fund data storing unit 53, and outputs an instruction for receiving the program acquisition charge to the program distribution device fund data storing unit 54 and outputs the receipt instruction for the inspection charge to the inspection device fund data storing unit 55.

The program distribution device fund data storing unit 54 receives the receipt instruction for the program acquisition charge and executes a data process for receiving the program acquisition charge to settlement fund data of the program distribution device 4 stored therein. More specifically, the data process for adding the money data corresponding to the program acquisition charge to the settlement fund data is executed.

The inspection device fund data storing unit 55 receives the receipt instruction for the inspection charge and executes a data process for receiving the inspection charge to settlement fund data of the inspection device 5 stored therein. More specifically, the data process for adding the money data corresponding to the inspection charge to the settlement fund data is executed (S194). Then, a sequence of payment processes is terminated.

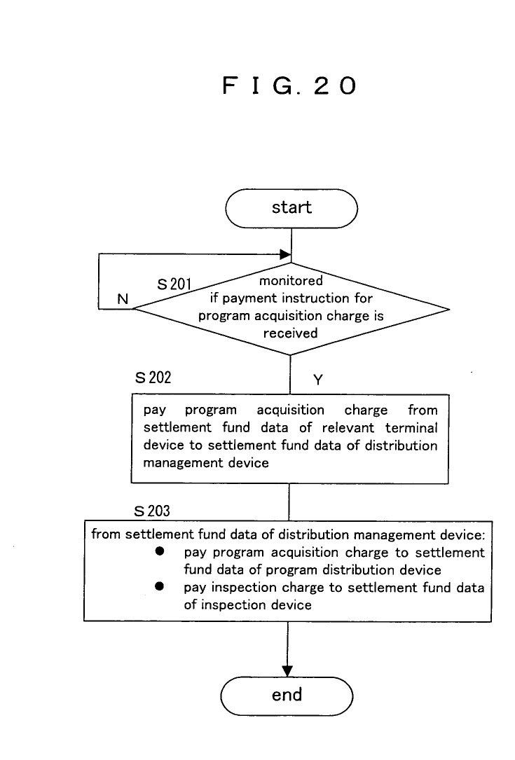

Next, a charging system and its processes in the case of the transmission/reception of the function program in the download system 1 are described referring to a flow chart of FIG. 20. In this case, the contents distribution device fund data storing unit 53 functions as a fund data storing unit of the distribution management device.

The terminal device 2 transmits the instruction for paying the program acquisition charge to the settlement management device 6 in response to the acquisition of the program from the program distribution device 4. In the settlement management device 6, it is monitored whether or not the payment instruction is received from the terminal device 2 (S201) by the data processor 51.

The data processor 51 confirms the reception of the instruction payment from the terminal device 2 in the S201, and outputs an instruction for paying the program acquisition charge to the terminal device fund data storing unit 52. The terminal device fund data storing unit 52 receives the payment instruction for the program acquisition charge and executes a data process for retrieving the program acquisition charge from the settlement fund data of the terminal device 2 stored therein. More specifically, the data process for subtracting money data corresponding to the program acquisition charge from the settlement fund data is executed.

The data processor 51 confirms the execution of the data process for retrieving the program acquisition charge in the terminal device fund data storing unit 52 and outputs an instruction for receiving the program acquisition charge to the contents distribution device fund data storing unit (functioning as distribution management device fund data storing unit) 53. The contents distribution device fund data storing unit 53 receives the receipt instruction for the program acquisition charge and executes a data process for receiving the program acquisition charge to the settlement fund data of the contents distribution device 3 stored therein. More specifically, the data process for adding the money data corresponding to the program acquisition charge to the settlement fund data is executed (S202).

The data processor 51 confirms the execution of the data process for receiving the program acquisition charge in the contents distribution device fund data storing unit 53 and outputs an instruction for paying the program acquisition charge and an instruction for paying the inspection charge to the contents distribution device fund data storing unit 53. The contents distribution device fund data storing unit 53 receives these payment instructions and executes data processes for retrieving the program acquisition charge and the inspection charge from the stored settlement fund data of the contents distribution device (functioning as distribution management device) 3. More specifically, the data process for subtracting the money data corresponding to the program acquisition charge from the settlement fund data and the data process for subtracting the money data corresponding to the inspection charge from the settlement fund data are executed.

The data processor 51 confirms the execution of the data processes for retrieving the program acquisition charge and the inspection charge in the contents distribution device fund data storing unit 53, and outputs an instruction for receiving the program acquisition charge to the program distribution device fund data storing unit 54 and an instruction for receiving the inspection charge to the inspection device fund data storing unit 55.

The program distribution device fund data storing unit 54 receives the receipt instruction for the program acquisition charge and executes a data process for receiving the program acquisition charge to the stored settlement fund data of the program distribution device 4. More specifically, the data process for adding the money data corresponding to the program acquisition charge to the settlement fund data is executed.

The inspection device fund data storing unit 55 receives the receipt instruction for the inspection charge and executes a data process for receiving the inspection charge to the stored settlement fund data of the inspection device 5. More specifically, the data process for adding the money data corresponding to the inspection charge to the settlement fund data is executed (S203). A sequence of payment processes is then terminated.

In the contents distribution device 3, transactions relating to the program distribution/management and transactions relating to the program inspection/management are generated. Handling charges generated from these transactions may be collected from the program distribution device 4 and the inspection device 5. When such handling charges are collected, a process for the payment of money data corresponding to the handling charges from the program distribution device fund data storing unit 54 and the inspection device fund data storing unit 55 to the contents distribution device fund data storing unit 53 is preferably executed on a regular basis (monthly, annually or the like).

Further, in the system in which a plurality of program distribution devices 4 and inspection devices 5 are provided, and one or more are optionally selected from the plurality of devices 4 and 5 on the terminal-device-2 side, information for introducing the plurality of devices 4 and 5 is distributed from the contents distribution device 3 to the terminal device 2. In such a case, in the distribution of the information for introducing the devices 4 and 5, the contents distribution device 3 is actually taking care of advertising transactions on behalf of the devices 4 and 5. Therefore, handling charges for the generated advertising transactions may be collected from the program distribution device 4 and the inspection device 5. In such a case, in the same manner as in the before-mentioned handling charges, a process for the payment of money data corresponding to the handling charges from the program distribution device fund data storing unit 54 and the inspection device fund data storing unit 55 to the contents distribution device fund data storing unit 53 is preferably executed on a regular basis (monthly, annually or the like).

In the described embodiment, the program is stored only in the program distribution device 4, and the program to be inspected is transmitted from the program distribution device 4 to the inspection device 5 every time when the program is inspected. In place of the constitution, a plurality of programs may be stored in the inspection device 5 so that the program to be inspected can be identified based on information for designating the program to be inspected transmitted together with the device information from the contents distribution device 3 to the inspection device 5 in each inspection. Then, the designated program to be inspected can be read from the programs stored in the inspection device 5 for the inspection.

While there has been described what is at present considered to be preferred embodiments of this invention, it will be understood that various modifications may be made therein, and it is intended to cover in the appended claims all such modifications as fall within the true spirit and scope of this invention.

1. An information contents download system comprising:
a terminal device comprising a hardware configuration capable of materializing optional information contents by adding a predetermined function thereto;
a contents distribution device for distributing the information contents;
a program distribution device for distributing a program for realizing the function used for the materialization in the terminal device of the information contents in the terminal device; and
an inspection device for reproducing and inspecting an execution state of the program in the terminal device, the respective devices being connected to one another to enable an intercommunication via an electric communication line, wherein
the terminal device transmits device information of the terminal device and a request for acquiring information contents desired by a user of the terminal device identified based on an instruction input operation implemented to the terminal device by the user of the terminal device to the contents distribution device, and receives the information contents desired by the user from the contents distribution device and the program required for the materialization of the desired information contents is received from the program distribution device, and
the terminal device further materializes the information contents by means of the function acquired in execution of the received program,
the contents distribution device judges whether or not a new program for realizing the function for materializing the information contents in the terminal device transmitting the acquisition request is necessary based on the information contents requested in the acquisition request received from the terminal device and the device information attached to the acquisition request, and transmits the information contents requested in the received acquisition request to the terminal device when the new program is judged to be unnecessary, and
the contents distribution device further designates the new program when the program is judged to be necessary, and transmits a request for distributing the designated program to the program distribution device and transmits the device information of the terminal device transmitting the acquisition request to the inspection device,
the program distribution device transmits the program designated in the distribution request received from the contents distribution device to the inspection device,
the inspection device reproduces a materialization state of the information contents using the program in the terminal device based on the program received from the program distribution device and the device information received from the contents distribution device and inspects a reproduction state thereof, and transmits a result of the inspection to the program distribution device and the contents distribution device,
the program distribution device transmits the program designated in the distribution request to the terminal device only when the inspection result received from the inspection device is favorable, and
the contents distribution device transmits the information contents indicated in the received acquisition request to the terminal device in the case of necessitating the new program in the terminal device only when the inspection result received from the inspection device is favorable.

2. An information contents download system as claimed in claim 1, wherein
the terminal device comprises:
an input unit for receiving an instruction input operation implemented to the terminal device by the user of the terminal device;
a transmitter for transmitting a signal including the acquisition request for the information contents desired by the user of the terminal device identified based on the instruction input operation implemented to the input unit by the user and device information of the terminal device to the contents distribution device;
a receiver for receiving a signal including the information contents desired by the user from the contents distribution device and receiving a signal including the program required for materializing the desired information contents from the program distribution device; and
an executor for materializing the information contents by means of the function obtained in execution of the program,
the contents distribution device comprises:
a receiver for receiving the signal including the acquisition request and the device information of the terminal device from the terminal device and a signal including the inspection result from the inspection device;
a designator for judging whether or not the new program is necessary for realizing the function for materializing the information contents in the terminal device transmitting the acquisition request based on the information contents requested in the received acquisition request and the device information attached to the acquisition request, the designator designating the new program when the new program is necessary;
a contents storing unit for storing the information contents; and
a transmitter for reading the information contents requested in the received acquisition request from the contents storing unit and transmitting the signal including the information contents to the terminal device, the transmitter further transmitting a signal including the distribution request for the program designated in the designator to the program distribution device and transmitting the signal including the device information of the terminal device transmitting the acquisition request to the inspection device,
the program distribution device comprises:
a receiver for receiving the signal including the distribution request from the contents distribution device and the signal including the inspection result from the inspection device;
a program storing unit for storing the program; and
a transmitter for reading the program designated in the received distribution request from the program storing unit and transmitting the signal including the program to the inspection device only when the received inspection result is favorable,
the inspection device comprises:
a receiver for receiving the signal including the program from the program distribution device and the signal including the device information of the terminal device desiring the program from the contents distribution device;
an inspector adapted to realize a device configuration of the terminal device on software based on the received device information and execute the program on the realized device configuration, the inspector further reproducing the materialization state of the information contents using the program in the terminal device based on the received program and device information and inspecting the reproduction state thereof; and
a transmitter for transmitting a signal including a result of the inspection of the inspector to the program distribution device and the contents distribution device, and
the transmitter of the contents distribution device transmits the signal including the information contents designated in the acquisition request when the new program is not necessary in the terminal device, and reads the information contents requested in the received acquisition request from the contents storing unit and transmits the signal including the information contents to the terminal device in the case of necessitating the new program in the terminal device only when the inspection result of the inspection device is favorable.

3. An information contents download system as claimed in claim 2, wherein
the transmitter of the terminal device transmits a signal including a request for presenting a list of the information contents inputted to the input unit by the user to the contents distribution device,
the designator of the contents distribution device generates a list of information of the information contents that can be materialized in the terminal device based on the list-presenting request and the device information received from the terminal device,
the transmitter of the contents distribution device transmits a signal including the list of information generated in the designator to the terminal device, and
the terminal device further comprises a presenter for presenting the list of information received from the contents distribution device to the user, and the input unit of the terminal device confirms contents of the acquisition request based on acknowledgment of the instruction input operation implemented to the input unit by the user referring to the list of information presented in the presenter.

4. An information contents download system as claimed in claim 3, wherein
a plurality of inspection devices is provided,
the designator of the contents distribution device generates the list of information including introduction information of the plurality of inspection devices,
the transmitter of the terminal device generates the acquisition request including a request for designating the inspection device based on acknowledgement of the instruction input operation implemented to the input unit by the user referring to the list of information presented in the presenter,
the designator of the contents distribution device designates the inspection device based on the designation request for the inspection device included in the acquisition request, and
the transmitter of the contents distribution device transmits the signal including the device information of the terminal device to the inspection device designated in the designator.

5. An information contents download system as claimed in claim 3, wherein
a plurality of program distribution devices is provided,
the designator of the contents distribution device generates the list of information including introduction information of the plurality of program distribution devices,
the transmitter of the terminal device generates the acquisition request including a request for designating the program distribution device based on acknowledgement of the instruction input operation implemented to the input unit by the user referring to the list of information presented in the presenter,
the designator of the contents distribution device designates the program distribution device based on the designation request for the program distribution device included in the acquisition request, and
the transmitter of the contents distribution device transmits the signal including the device information of the terminal device transmitting the acquisition request to the program distribution device designated in the designator.

6. An information contents download system as claimed in claim 2, wherein
a program storing unit for storing the program is provided in the inspection device,
the transmitter of the contents distribution device transmits a signal including a request for designating the program to the inspection device, and
the inspector of the inspection device reads the program designated in the received program designation request from the program storing unit of the inspection device and inspects the program.

7. A function download system comprising:
a terminal device comprising a hardware configuration capable of realizing an optional function on software;
a program distribution device for distributing a program for realizing the function in the terminal device;
a distribution management device for managing distribution of the program; and
an inspection device for reproducing and inspecting an execution state of the program in the terminal device, the respective devices being connected to one another to enable an intercommunication via an electric communication line, wherein
the terminal device transmits device information of the terminal device and a request for acquiring a function desired by a user of the terminal device and acknowledged based on the instruction input operation implemented to the terminal device by the user to the distribution management device, receives the program corresponding to the function desired by the user from the program distribution device, and executes the received program,
the distribution management device designates a program required for realizing the function in the terminal device transmitting the acquisition request based on the function designated in the acquisition request received from the terminal device and the device information attached to the acquisition request, transmits a request for distributing the designated program to the program distribution device, and transmits the device information of the terminal device transmitting the acquisition request to the inspection device,
the program distribution device transmits the program designated in the distribution request received from the distribution management device to the inspection device,
the inspection device reproduces an execution state of the program in the terminal device based on the program received from the program distribution device and the device information received from the distribution management device, inspects a reproduction state thereof, and transmits a result of the inspection to the program distribution device, and
the program distribution device further transmits the program required for realizing the function desired by the terminal device in the terminal device to the terminal device only when the inspection result received from the inspection device is favorable.

8. A function download system as claimed in claim 7, wherein
the terminal device comprises:
an input unit for receiving an instruction input operation carried out to the terminal device by the user of the terminal device;
a transmitter for transmitting a signal including the acquisition request for the function desired by the user of the terminal device identified based on the instruction input operation implemented to the input unit by the user and the device information of the terminal device to the distribution management device;
a receiver for receiving a signal including the program corresponding to the function desired by the user from the program distribution device; and
an executor for executing the received program,
the distribution management device comprises:
a receiver for receiving the signal including the acquisition request and the device information of the terminal device from the terminal device;
a designator for designating a program required for realizing the function in the terminal device transmitting the acquisition request based on the function designated in the received acquisition request and the device information attached to the acquisition request; and
a transmitter for transmitting a signal including a request for distributing the program designated in the designator to the program distribution device and the signal including the device information of the terminal device transmitting the acquisition request to the inspection device,
the program distribution device comprises:
a receiver for receiving the signal including the distribution request from the distribution management device and receiving a signal including a result of the inspection from the inspection device;
a program storing unit for storing the program; and
a transmitter for reading the program designated in the received distribution request from the program storing unit and transmitting the signal including the program to the inspection device,
the inspection device comprises:
a receiver for receiving the signal including the program from the program distribution device and receiving the signal including the device information of the terminal device desiring the program from the distribution management device;
an inspector adapted to realize a device configuration of the terminal device on software based on the received device information and execute the program on the realized device configuration, the inspector further reproducing an execution state of the program in the terminal device based on the received program and device information and inspecting a reproduction state thereof; and
a transmitter for transmitting a signal including a result of the inspection of the inspector to the program distribution device, and
the transmitter of the program distribution device reads the program required for realizing the function desired by the terminal device in the terminal device from the program storing unit and transmits the signal including the program to the terminal device only when the received inspection result is favorable.

9. A function download system as claimed in claim 8, wherein
the transmitter of the terminal device transmits a signal including a request for presenting a list of the functions inputted to the input unit by the user to the distribution management device,
the designator of the distribution management device generates a list of information of the functions realizable in the terminal device based on the list-presenting request and the device information received from the terminal device,
the transmitter of the distribution management device transmits a signal including the list of information generated in the designator to the terminal device,
the terminal device further comprises a presenter for presenting the list of information received from the distribution management device to the user, and
the input unit of the terminal device confirms contents of the acquisition request based on acknowledgement of the instruction input operation implemented to the input unit by the user referring to the list of information presented in the presenter.

10. A function download system as claimed in claim 9, wherein
a plurality of inspection devices is provided,
the designator of the distribution management device generates the list of information including introduction information of the plurality of inspection devices,
the transmitter of the terminal device generates the acquisition request including a request for designating the inspection device based on acknowledgement of the instruction input operation implemented to the input unit by the user referring to the list of information presented in the presenter,
the designator of the distribution management device designates the inspection device based on the designation request included in the acquisition request, and
the transmitter of the distribution management device transmits the signal including the device information of the terminal device transmitting the acquisition request to the inspection device designated in the designator.

11. A function download system as claimed in claim 9, wherein
a plurality of program distribution devices is provided,
the designator of the distribution management device generates the list of information including introduction information of the plurality of program distribution devices,
the transmitter of the terminal device generates the acquisition request including a request for designating the program distribution device based on acknowledgement of the instruction input operation implemented to the input unit by the user referring to the list of information presented in the presenter,
the designator of the distribution management device designates the program distribution device based on the designation request included in the acquisition request, and
the transmitter of the distribution management device transmits the signal including the device information of the terminal device transmitting the acquisition request to the program distribution device designated in the designator.

12. A function download system as claimed in claim 8, wherein
the inspection device stores the program,
the transmitter of the distribution management device transmits a signal including a request for designating the program to the inspection device, and
the inspector of the inspection device reads the program designated in the received program designation request from the inspection device and inspects the program.

13. A contents distribution device connected to:
a terminal device comprising a hardware configuration capable of realizing an optional function software;
a program distribution device for distributing a program for realizing the function in the terminal device; and
an inspection device for reproducing and inspecting an execution state of the program in the terminal device to enable an intercommunication via an electric communication line, comprising:
a receiver for receiving a signal including a request for acquiring information contents desired by a user of the terminal device and device information of the terminal device from the terminal device and receiving a signal including a result of the inspection from the inspection device;
a designator for judging whether or not a new program is necessary for realizing the function for materializing the information contents in the terminal device transmitting the acquisition request based on the information contents requested in the received acquisition request and the device information attached to the acquisition request, the designator designating the new program when the new program is necessary;
a contents storing unit for storing the information contents; and
a transmitter for transmitting a signal including a request for distributing the program designated in the designator to the program distribution device, transmitting the signal including the device information of the terminal device transmitting the acquisition request, and reading the information contents designated in the acquisition request from the contents storing unit and transmitting a signal including the information contents to the terminal device, wherein
the transmitter transmits the signal including the information contents designated in the acquisition request when the new program is not necessary in the terminal device, and transmits the signal including the information contents designated in the acquisition request to the terminal device in the case of necessitating the new program in the terminal device only when the inspection result received from the inspection device is favorable.

14. A program distribution device connected to:
a terminal device comprising a hardware configuration capable of materializing optional information contents by adding a predetermined function thereto;
a contents distribution device for distributing the information contents; and
an inspection device for reproducing and inspecting an execution state in the terminal device of a program for realizing in the terminal device the function used for the materialization of the information contents in the terminal device to enable an intercommunication via an electric communication line, comprising:
a receiver for receiving a signal including a request for distributing the program from the contents distribution device and a signal including a result of the inspection from the inspection device;
a program storing unit for storing the program; and
a transmitter for reading the program designated in the distribution request from the program storing unit and transmitting a signal including the program to the inspection device, the transmitter further reading the program designated in the distribution request from the program string unit and transmitting the signal including the program to the terminal device only when the inspection result received from the inspection device is favorable.

15. An inspection device connected to:
a terminal device comprising a hardware configuration capable of materializing optional information contents by adding a predetermined function thereto;
a contents distribution device for distributing the information contents; and
a program distribution device for distributing a program for realizing the function used for the materialization in the terminal device of the information contents in the terminal device to enable an intercommunication via an electric communication line, comprising:
a receiver for receiving a signal including the program from the program distribution device and receiving a signal including device information of the terminal device desiring the program from the contents distribution device;
an inspector adapted to realize a device configuration of the terminal device on software based on the received device information and execute the program on the realized device configuration, the inspector further reproducing a materialization state of the information contents using the program in the terminal device based on the received program and device information and inspecting a reproduction state thereof; and
a transmitter for transmitting a signal including a result of the inspection of the inspector to the program distribution device and the contents distribution device.

16. A distribution management device connected to:
a terminal device comprising a hardware configuration capable of realizing an optional function on software;
a program distribution device for distributing a program for realizing the function used for the materialization in the terminal device of the information contents in the terminal device; and
an inspection device for reproducing and inspecting an execution state of the program in the terminal device to enable an intercommunication via an electric communication line, comprising:
a receiver for receiving a signal including a request for acquiring a function desired by a user of the terminal device and device information of the terminal device from the terminal device and receiving a signal including a result of the inspection of the inspection device from the inspection device;
a designator for designating the program required for realizing the function in the terminal device transmitting the acquisition request based on the function requested in the acquisition request and the device information attached to the acquisition request; and
a transmitter for transmitting a signal including a request for distributing the program designated in the designator to the program distribution device and transmitting the signal including the device information of the terminal device transmitting the acquisition request to the inspection device.

17. A program distribution device connected to:
a terminal device comprising a hardware configuration capable of realizing an optional function on software;
a distribution management device for managing distribution of a program for realizing the function in the terminal device; and
an inspection device for reproducing and inspecting an execution state of the program in the terminal device to enable an intercommunication via an electric communication line, comprising:
a receiver for receiving a signal including a request for distributing the program from the distribution management device and receiving a signal including a result of the inspection of the inspection device from the inspection device;
a program storing unit for storing the program; and
a transmitter for reading the program designated in the distribution request from the program storing unit and transmitting a signal including the program to the inspection device, the transmitter further reading the program designated in the distribution request from the program storing unit and transmitting the signal including the program to the terminal device only when the inspection received from the inspection device is favorable.

18. An inspection device connected to:
a terminal device comprising a hardware configuration capable of realizing an optional function on software;
a program distribution device for distributing a program for realizing the function in the terminal device; and
a distribution management device for managing distribution of the program to enable an intercommunication via an electric communication line, comprising:
a receiver for receiving a signal including the program from the program distribution device and receiving a signal including device information of the terminal device desiring the program from the distribution management device;
an inspector adapted to realize a device configuration of the terminal device on the software based on the received device information and execute the program on the realized device configuration, the inspector further reproducing an execution state of the program in the terminal device based on the received program and device information and inspecting a reproduction state thereof; and
a transmitter for transmitting a signal including a result of the inspection of the inspector to the program distribution device.

19. An information contents download charging system comprising:
a terminal device comprising a hardware configuration capable of materializing optional information contents by adding a predetermined function thereto;
a contents distribution device for distributing the information contents;
a program distribution device for distributing a program for realizing the function used for the materialization in the terminal device of the information contents in the terminal device;
an inspection device for reproducing and inspecting an execution state of the program in the terminal device; and
a settlement management device for managing respective settlement fund data of the terminal device, the contents distribution device, the program distribution device and the inspection device, the respective devices being connected to one another to enable an intercommunication via an electric communication line, wherein
the program distribution device distributes the program to the terminal device and the contents distribution device distributes the information contents to the terminal device only when a result of the inspection of the inspection device is favorable,
the terminal device transmits an instruction for paying a contents acquisition charge to the settlement management device when the information contents are acquired from the contents distribution device, and
the settlement management device executes a data process for paying the contents acquisition charge from the settlement fund data of the terminal device to the settlement fund data of the contents distribution device, a data process for paying a charge for acquiring the program from the settlement fund data of the contents distribution device to the settlement fund data of the program distribution device, and a data process for paying an inspection charge from the settlement fund data of the contents distribution device to the settlement fund data of the inspection device in response to reception of the payment instruction.

20. A function download charging system comprising:
a terminal device comprising a hardware configuration capable of realizing an optional function on software;
a program distribution device for distributing a program for realizing the function in the terminal device;
a distribution management device for managing distribution of the program;
an inspection device for reproducing and inspecting an execution state of the program in the terminal device; and
a settlement management device for managing respective settlement fund data of the terminal device, the program distribution device, the distribution management device and the inspection device, the respective devices being connected to one another to enable an intercommunication via an electric communication line, wherein
the program distribution device distributes the program to the terminal device only when a result of the inspection of the inspection result is favorable,
the terminal device transmits an instruction for paying a program acquisition charge to the settlement management device when the program is acquired from the program distribution device, and
the settlement management device executes a data process for paying the program acquisition charge from the settlement fund data of the terminal device to the settlement fund data of the distribution management device, a data process for paying the program acquisition charge from the settlement fund data of the distribution management device to the settlement fund data of the program distribution device, and a data process for paying an inspection charge from the settlement fund data of the distribution management device to the settlement fund data of the inspection device in response to reception of the payment instruction.
